(19) United States
(12) Patent Application Publication
(10) Pub. No.: US 2011/0044048 A1
(43) Pub. Date: Feb. 24, 2011

(54) REMOVABLE ATTACHMENT ASSEMBLY FOR DROPLIGHT

(75) Inventor: Frank Jude Villecco, Wantagh, NY (US)

Correspondence Address: HOFFMANN & BARON, LLP, 6900 JERICHO TURNPIKE, SYOSSET, NY, 11791, US

(73) Assignee: PIONEER INVENTIONS, INC., Floral Park, NY (US)

(21) Appl. No.: 12/543,082

(22) Filed: Aug. 18, 2009

(51) Int. Cl. F21V 19/02

(52) U.S. Cl. 362/285

(57) ABSTRACT

An attachment assembly for a droplight and a method of attaching a droplight are disclosed. The attachment assembly includes a mounting plate, at least one leaf-spring assembly and a clamp. The mounting plate is configured to be disposed over a reflector of the droplight. The reflector includes a rim that has a first side and a second side. The at least one leaf-spring assembly is secured to a first end of the mounting plate and biased away from a second end of the mounting plate. The at least one leaf-spring assembly includes a first hook configured to engage the first side of the rim and a second hook configured to engage the second side of the rim. The clamp is secured to the mounting plate in adjustable configuration and configured to secure the mounting plate to a supporting structure.

### TECHNICAL FIELD

The present application relates generally to electrical droplights. More specifically, the present application is directed to a removable attachment assembly for a droplight configured for trouble-free connection to and disconnection from the droplight.

### BACKGROUND

An electrical work light or trouble light, which is commonly known as a droplight, can be held or hung to increase the amount of light in a dimly-lit work area. Generally, a droplight includes a housing coupled to a handle that supports an electrical socket connected to an extension cord. The housing—configured to securely house a light bulb that is screwed into the socket—includes a reflector to reflect light emitted by the light bulb and a wire guard hinged to the reflector to facilitate transmission of light and replacement of the light bulb.

The housing typically includes a hook to permit hanging of the droplight in close proximity to the work area. Specifically, the hook permits attachment of the droplight to a variety of hook-supporting structures in the work area. Often, however, the work area may not have a hook-supporting structure in close proximity to where additional light may be required.

Various mounts or supports have been developed over the years to secure the droplight in close proximity to the work area that lacks a hook-supporting structure. However, such mounts or supports require complex connection to the droplight. It is also difficult or at best cumbersome to disconnect the various mounts or supports from the droplight. As a result, these mounts or supports are typically never disconnected from the droplight, making their use and reusability non-practical and contributing to their commercial non-desirability.

### SUMMARY

A removable attachment assembly for a droplight and a method of attaching the droplight are disclosed herein.

The attachment assembly includes a mounting plate, at least one leaf-spring assembly and a clamp. The mounting plate is configured to be disposed over a reflector of the droplight. The reflector includes a rim that has a first side and a second side. The at least one leaf-spring assembly is secured to a first end of the mounting plate and biased away from a second end of the mounting plate. The at least one leaf-spring assembly includes a first hook configured to engage the first side of the rim and a second hook configured to engage the second side of the rim. The clamp is secured to the mounting plate in adjustable configuration and configured to secure the mounting plate to a supporting structure.

The method includes disposing a mounting plate of an attachment assembly over the reflector of the droplight. The attachment assembly includes at least one leaf-spring assembly secured to a first end of the mounting plate and biased away from a second end of the mounting plate and an adjustable clamp. Thereafter, the at least one leaf-spring assembly is secured to a first side of the rim. The at least one leaf-spring assembly is deflected downward and peripherally outward with respect to a second side of the rim. The at least one leaf-spring assembly is then secured to a first side of the rim.

The attachment assembly and method of attaching provide the ability to secure the droplight in close proximity to the work area where additional light may be required, especially when the work area lacks a hook-supporting structure. In addition, the attachment assembly and method of attaching mitigate the complex and often cumbersome connection and disconnection of the prior art mounts or supports, making use and reusability of the attachment assembly practical and contributing to its commercial desirability.

For a more thorough understanding of the attachment assembly and method of attaching, reference is made to the following description, taken in conjunction with the accompanying drawings.

### BRIEF DESCRIPTION OF THE DRAWINGS

Some embodiments are shown by way of example and not limitation in the figures of the accompanying drawings in which:

FIG. 1 shows a front elevational view of an example removable attachment assembly for a droplight;

FIG. 2A shows a rear elevational view of the example removable attachment assembly of FIG. 1;

FIG. 2B shows a rear elevational view of an alternate embodiment of the example removable attachment assembly of FIG. 1;

FIG. 3A shows a bottom elevational view of the example removable attachment assembly of FIG. 1;

FIG. 3B shows a bottom elevational view of the alternate removable attachment assembly of FIG. 2B;

FIG. 4 shows the example removable attachment assembly of FIG. 1 in a first partially attached position with regard to a housing of the droplight;

FIG. 5 shows the example removable attachment assembly of FIG. 4 in a second biased position with regard to the housing of the droplight;

FIG. 6 shows the example removable attachment assembly of FIG. 5 in a third fully attached position with regard to the housing of the droplight;

FIG. 7 shows the example attachment assembly of FIG. 1 that secures a droplight to a supporting structure; and

FIG. 8 shows the example attachment assembly of FIG. 1 that secures the droplight to a supporting structure.

### DETAILED DESCRIPTION

An example removable attachment assembly for a droplight and an example method of attaching a droplight are disclosed herein. In the following description, for the purposes of explanation, numerous specific details are set forth in order to provide a thorough understanding of example embodiments. It will be evident, however, to one skilled in the art, that an example embodiment may be practiced without all of the disclosed specific details.

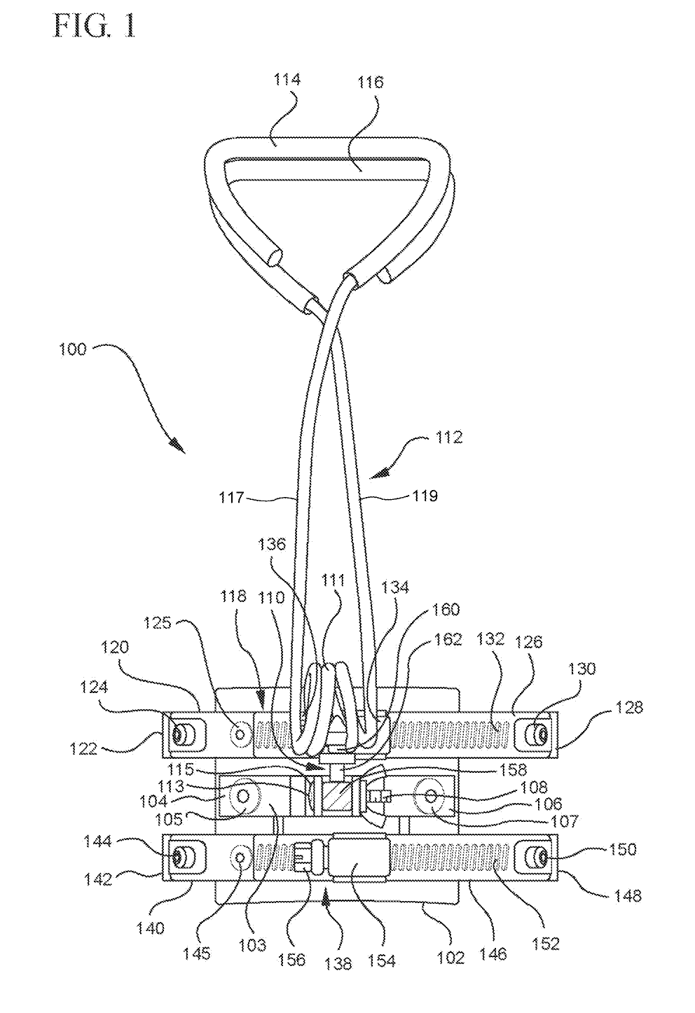

FIG. 1 shows a front elevational view of an example attachment assembly 100 for a droplight. The attachment assembly 100 is configured to provide trouble-free connection to and disconnection from the droplight and further configured to provide removable mounting of the droplight to a supporting structure. The attachment assembly 100 can be made of a variety of materials and combinations of materials, including metal, plastic and other conventional materials. The attachment assembly 100 includes a mounting plate 102, brackets 104, 106, a connector 110, a clamp 112, and leaf-spring assemblies 118, 138.

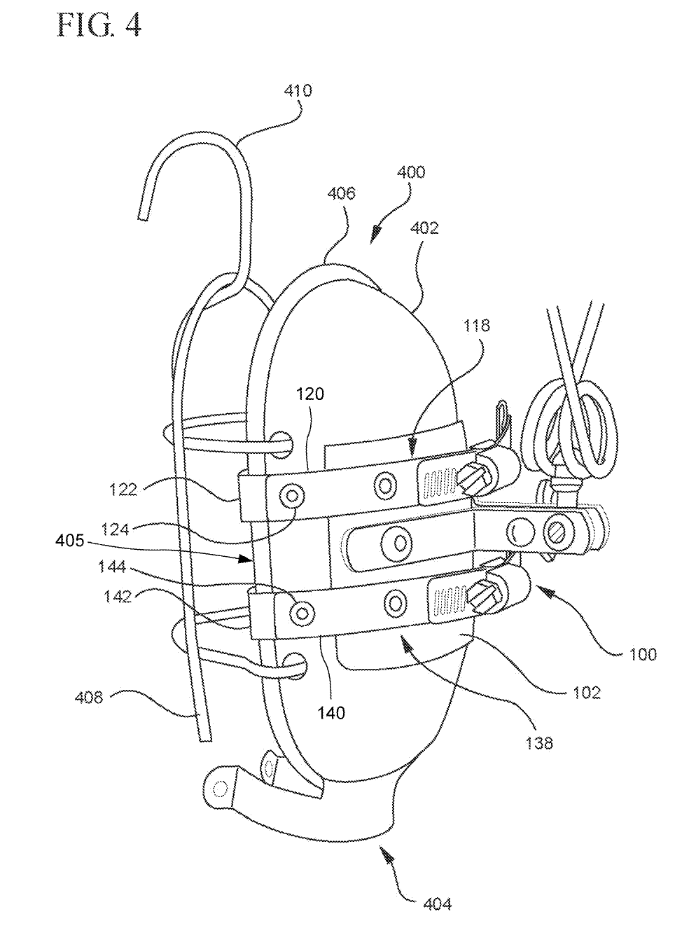

The mounting plate 102 of the attachment assembly 100 is configured to be disposed on or over a reflector of a droplight housing. Specifically, the mounting plate 102 is generally of an arcuate configuration that is configured to easily mate with a generally arcuate configuration of the reflector that is shown in FIG. 4, which will be described in greater detail below.

The brackets 104, 106 of the attachment assembly 100 are configured to be secured to the mounting plate 102 and further configured to removably secure the connector 110. Specifically, each of the brackets 104, 106 includes a base 103 and an arm 109. The base 103 is of an arcuate configuration and is configured to be secured to the arcuate mounting plate 102 along the curvature of the mounting plate 102. The arm 109 is substantially upright in relation to the base 103 and is configured to rise substantially upward from the mounting plate 102.

The brackets 104, 106 are disposed at a predetermined distance from each other on opposite sides of the curvature of the mounting plate 102, providing a space between their respective arms 109 that is sufficient to support the connector 110 between the arms 109. Each arm 109 of the brackets 104, 106 can include a cavity or a depression 115 configured to receive the connector 110 and an opening 113 configured to receive fastener 108 (e.g., a bolt secured by wing nut) to secure the connector 110 between the arms 109 of the brackets 104, 106. The brackets 104, 106 are secured to the mounting plate 102 via respective fasteners 105, 107. The fasteners 105, 107 can include screws, rivets, or other conventional or yet to be developed fasteners. In one example embodiment, the brackets 104,106 can be spot-welded to the mounting plate 102 at one or more locations along the base 103 of each respective bracket 104,106. In another example embodiment, the mounting plate 102 and the brackets 104, 106 can be monolithic (e.g., formed or manufactured as one piece).

The connector 110 of the attachment assembly 100 is configured to connect the clamp 112 to the attachment assembly 100, allowing the clamp 112 to pivot and rotate with respect to the mounting plate 102. The connector includes a first end 158, a second end 160 and a body 162. The first end 158 is configured to be pivotally secured between the brackets 104, 106 via respective cavities 115 and the fastener 108. The first end 158 can be knurled to facilitate a more rigid connection to the brackets 104, 106. The second end 160 is configured to be secured to the clamp 112 via the coils 111. The body 162 provides sufficient distance between the brackets 104, 106 and the clamp 112 to enable the clamp 112 to pivot in relation to the mounting plate 102, and further to rotate in relation to the mounting plate 102.

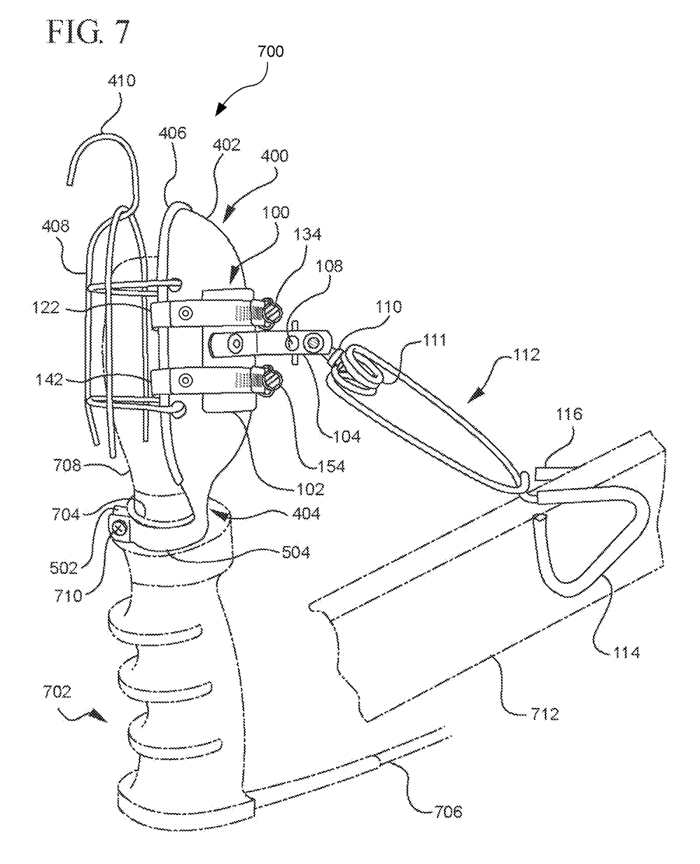

The clamp 112 of the attachment assembly 100 is configured to secure to the connector 110 to a supporting structure that is shown in FIG. 7, which will be described in greater detail below. The clamp 112 includes coils 111, arms 117, 119, and tongues 114, 116. The arms 117, 119 connect respective tongues 114, 116 to the coils 111. The coils 111 are configured to receive and secure the second end 160 of the connector 110 between the coils 111. The coils 111 are further configured to bias the tongue 114 to a closed position with respect to the tongue 116. The biasing facilitates removable mounting of the clamp 112 to a supporting structure via the tongues 114, 116, as particularly shown in FIG. 7. The arms 117, 119 are configured to be deflected toward one another to open the tongues 114, 116 and released to the close the tongues 114, 116.

The leaf-spring assemblies 118, 138 of the attachment assembly 100 are configured to removably secure the attachment assembly 100 to the reflector of the droplight housing. The leaf-spring assemblies 118, 138 extend along the mounting plate 102 on alternate sides of the brackets 104, 106, which extend inline between the leaf-spring assemblies 118, 138 and along the curvature of the mounting plate 102. Each of the leaf-spring assemblies 118, 138 includes one or more resilient yet flexible leaf-spring members (as described below) capable of being deflected to provide tension in the leaf-spring assemblies 118, 138 and further capable of being released to remove the tension from the leaf-spring assemblies 118, 138.

The leaf-spring assembly 118 includes leaf-spring members 120, 126 and a leaf-spring adjustment member 134. The leaf-spring members 120, 126 are secured with respect to one another via the leaf-spring adjustment member 134 and are adjustable via a screw 136 of the leaf-spring adjustment member 134. For example, the leaf-spring adjustment member 134 can be a worm drive that adjusts or drives the leaf-spring member 126 with respect to the leaf-spring member 120 using slots 132 in the leaf-spring member 126. Specifically, the leaf-spring adjustment member 134 via the screw 136 adjusts the length of the leaf-spring member 126 with respect to the leaf-spring member 120. Thus, the leaf-spring adjustment member 134 provides an adjustable length of the leaf-spring assembly 118, allowing the attachment assembly 100 to be removably secured to differently-sized reflectors. Other leaf-spring adjustment members that are configured to adjust leaf-spring members 120, 126 with respect to one another can be used.

The leaf-spring member 120 of the leaf-spring assembly 118 is secured to the mounting plate 102 at a first end of its curvature via a fastener (e.g., rivet) 125, enabling the leaf-spring assembly 118 to be biased away from a second end of the mounting plate 102. In an example embodiment, the leaf-spring member 120 can be spot-welded to the mounting plate 102. The leaf-spring member 120 includes a hook 122 and a handle 124. The hook 122 is configured to secure to a first side of a rim of the reflector, as particularly shown in FIG. 4. The hook 122 can be configured from one end of the leaf-spring member 120 or can be a separate hook (e.g., heavier-gauge hook) that is attached to the end of the leaf-spring member 120 via a fastener, such as rivet or other conventional or yet to be developed fastener. In one example embodiment, the hook 122 can be spot-welded to the leaf-spring member 120.

The handle 124 is configured to provide assistance to a person to engage the hook 122 to the rim of the reflector and to disengage the hook 122 from the rim of the reflector (e.g., such as by using one's thumb). In one example embodiment, handle 124 can be a head of a fastener (e.g., rivet) that secures the hook 122 to the leaf-spring member 120. In another example embodiment, the handle 124 can be replaced by one or more ridges, knurls, beads and/or other protrusions or a coating capable of being gripped or providing sufficient friction (e.g., such as by using one's thumb) to assist in engaging the hook 122 to the rim of the reflector and to disengage the hook 122 from the rim of the reflector.

The leaf-spring member 126 of the leaf-spring assembly 118 also includes a hook 128 and a handle 130. The hook 128 is configured to secure to an opposite second side of the rim of the reflector. The hook 128 can be configured from one end of the leaf-spring member 126, can be a separate hook (e.g., heavier-gauge hook) that is attached to the end of the leaf-spring member 126 via a fastener, such as a rivet or other conventional or yet to be developed fastener, or can be spot-welded to the leaf-spring member 126.

The handle 130 is configured to provide assistance to a person to engage the hook 128 to the second side of the rim or to disengage the hook 128 from the second side of the rim of the reflector. In one example embodiment, handle 130 can be a head of a fastener (e.g., rivet) that secures the hook 128 to the leaf-spring member 126. In another example embodiment, the handle 130 can be replaced by one or more ridges, knurls, beads and/or other protrusions or a coating capable of being gripped or providing sufficient friction (e.g., such as by using one's thumb) to assist in engaging the hook 128 to the rim of the reflector and to disengage the hook 128 from the rim of the reflector.

The leaf-spring assembly 138 includes leaf-spring members 140, 146, secured with respect to one another via a leaf-spring adjustment member 154 and are adjustable via a screw 156 of the leaf-spring adjustment member 154. The leaf-spring adjustment member 154 can be a worm drive that adjusts or drives the leaf-spring members 146 with respect to the leaf-spring member 140 using slots 152 in the leaf-spring member 146. Thus, the leaf-spring adjustment member 154 provides an adjustable length of the leaf-spring assembly 138, allowing the attachment assembly 100 to be removably secured to differently-sized reflectors. Other leaf-spring adjustment members that are configured to adjust leaf-spring members 140, 146 with respect to one another can also be used.

The leaf-spring member 140 of the leaf-spring assembly 138 is secured to the mounting plate 102 at a first end of its curvature via fastener (e.g., rivet) 145, enabling the leaf-spring assembly 138 to be biased away from a second end of the mounting plate 102. In an example embodiment, the leaf-spring member 140 can be spot-welded to the mounting plate. The leaf-spring member 140 is spaced apart from the leaf-spring member 120 along the first end of the mounting plate 102. The leaf-spring member 140 includes a hook 142 and a handle 144. The hook 142 is configured to secure to the first side of the rim of the reflector. The hook 142 can be configured from one end of the leaf-spring member 140 or can be a separate hook (e.g., heavier-gauge hook) that is attached to the end of the leaf-spring member 140 via a fastener, such as a rivet or other conventional or yet to be developed fastener. In one example embodiment, the hook 142 can be spot-welded to the leaf-spring member 140.

The handle 144 is configured to provide assistance to a person to engage the hook 142 to the rim and disengage the hook 142 from the rim of the reflector (e.g., such as by using one's thumb). In one example embodiment, the handle 144 can be a head of fastener (e.g., rivet) that secures the hook 142 to the leaf-spring member 140. In another example embodiment, the handle 144 can be replaced by one or more ridges, knurls, beads and/or other protrusions or a coating capable of being gripped or providing sufficient friction (e.g., such as by using one's thumb) to assist in engaging the hook 142 to the rim of the reflector and to disengage the hook 142 from the rim of the reflector.

The leaf-spring member 146 of the leaf-spring assembly 138 includes a hook 148 and a handle 150. The hook 148 is configured to secure to the opposite second side of the rim of the reflector. The hook 148 can be configured from one end of the leaf-spring member 146, can be a separate hook (e.g., heavier-gauge hook) that is attached to the end of the leaf-spring member 146 via a fastener, such as a rivet or other conventional or yet to be developed fastener, or can be spot-welded to the leaf-spring member 146.

The handle 150 is configured to provide assistance to a person to engage the hook 148 to the second side of the rim or to disengage the hook 148 from the second side of the rim of the reflector. In one example embodiment, handle 150 can be a head of a fattener (e.g., rivet) that secures the hook 148 to the leaf-spring member 146.

In some example embodiments, the leaf-spring assembly 118 can be made of one monolithic leaf-spring member without the leaf-spring adjustment member 134 and/or the leaf-spring assembly 138 can be made of one monolithic leaf-spring member without the leaf-spring adjustment member 154. The monolithic leaf-spring members of the leaf-spring assemblies 118, 138 can be secured to the mounting plate 102 as described herein. The hooks 122, 128 and 142, 148 can be configured from the ends of the monolithic leaf-spring members, or can be a separate hooks (e.g., heavier-gauge hooks) that are attached to the ends of the monolithic leaf-spring members via fasteners (e.g., rivets) or spot-welded. The monolithic leaf-spring members can be configured to lengths that enable the attachment assembly 100 to be removably secured to a particularly-sized reflector. Attachment assemblies 100 having monolithic leaf-spring members of other lengths can be provided for differently-sized reflectors.

In some other example embodiments, a single leaf-spring assembly 118 or 138 can be secured to the mounting plate 102, as described herein. The single leaf-spring assembly can include two leaf-spring members connected by a leaf-spring adjustment member or a single monolithic leaf-spring member, as described herein. In such other embodiments, the leaf-spring assembly can be disposed more centrally along the mounting plate 102, as compared to the embodiments with multiple leaf-spring assemblies 118, 138, to secure the mounting plate 102 securely to the reflector and further in operation to distribute any forces more evenly along the singe leaf-spring assembly.

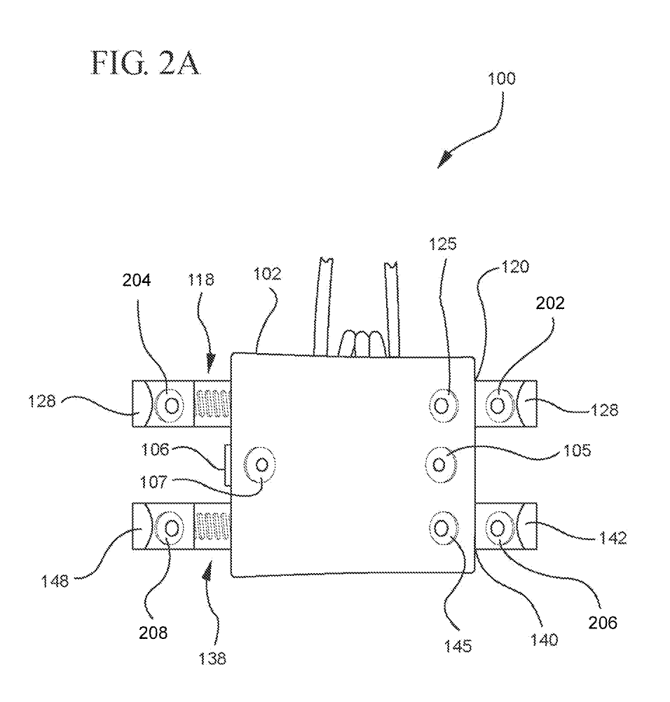

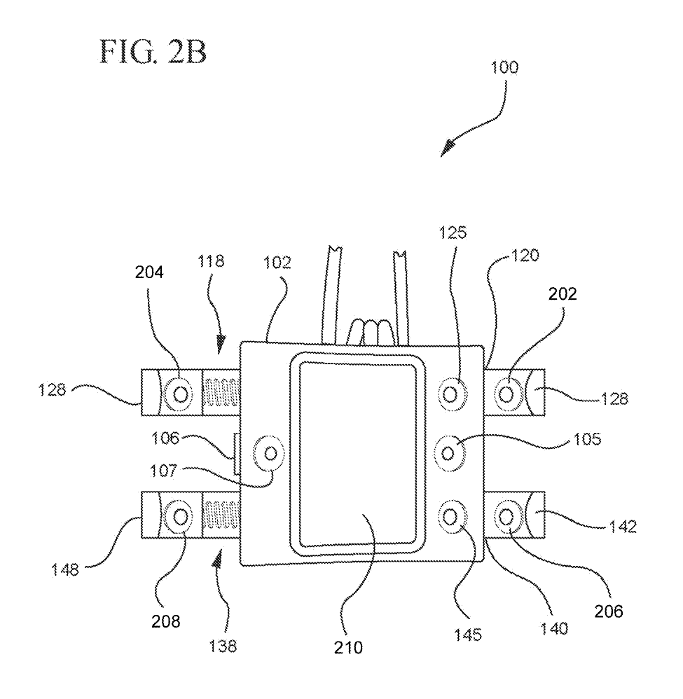

FIG. 2A shows a rear elevational view of the example attachment assembly 100 for a droplight of FIG. 1. As particularly shown in FIG. 2A, the hooks 122, 128 and 142, 148 can be secured to respective leaf-spring assemblies 118, 138 via fasteners 202, 204 and 206, 108, such as rivets. In one example embodiment, the fasteners 202, 204 and 206, 208 form respective handles 122, 130 and 144, 150, as shown in FIG. 1. As further shown in FIG. 2A, the fasteners 105, 107 secure respective brackets 104, 106 to the mounting plate 102 and the fasteners 125, 145 (e.g., rivets) secure leaf-spring members 120, 140 of the respective leaf-spring assemblies 118, 138 at a distance from one another along the first end of the mounting plate 102. The separation provides for better (e.g., more stable, balanced, rigid and secure) connection of the attachment assembly 100 to the reflector of the droplight.

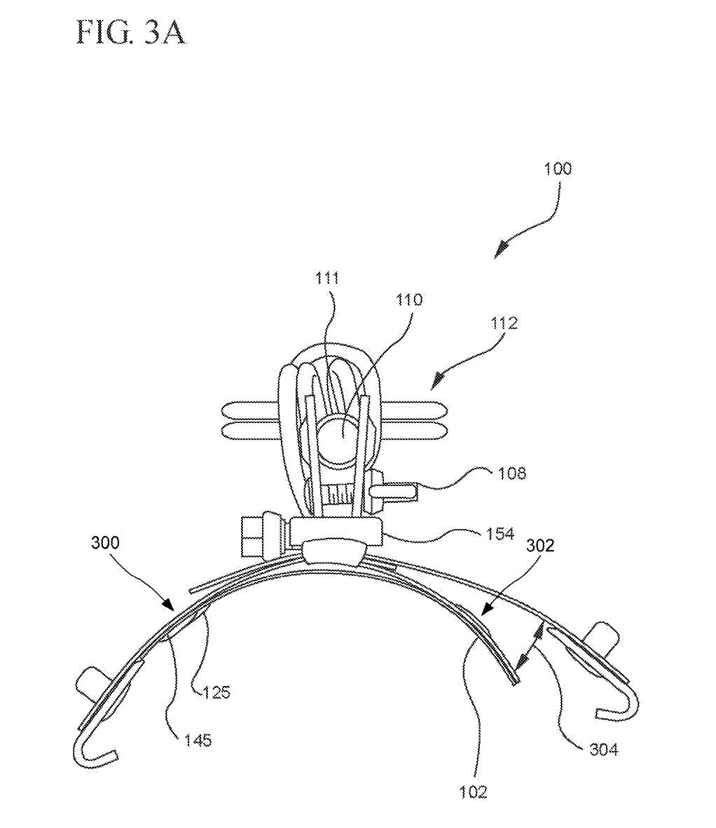

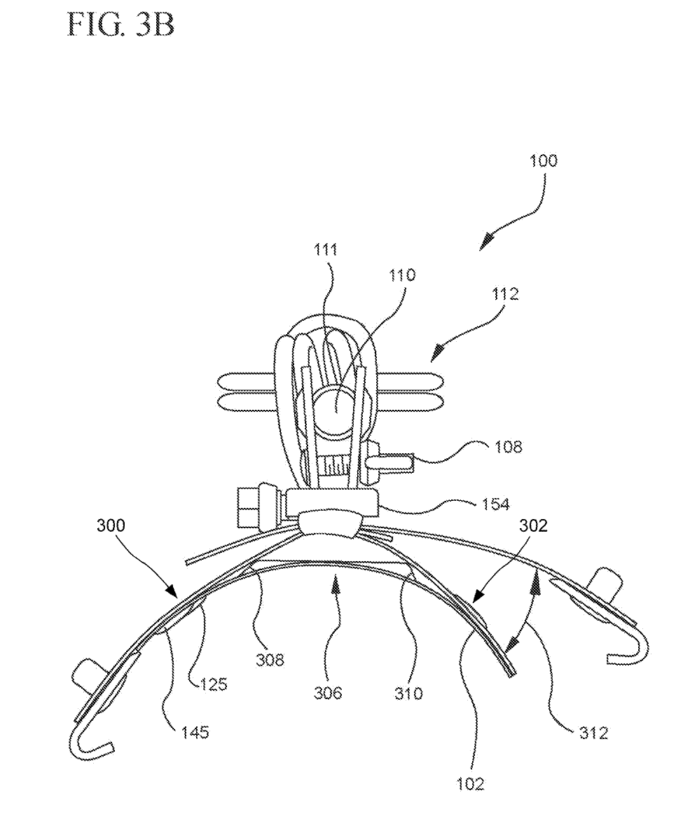

FIG. 2B shows a rear elevational view of an alternate embodiment of the example removable attachment assembly 100 of FIG. 1. As particularly shown in FIG. 2B, the mounting plate 102 includes a cavity or depression 210 about the center of the mounting plate 102. The cavity or depression 210 can be stamped into the mounting plate 102 to produce a reciprocally projecting closed structure on the front of the example assembly 100 that is shown in FIG. 3B, which will be described in greater detail below. The cavity or depression 210 can be used to receive a Universal Product Code (“UPC”) label, as well as any other product information label or other insignia. The cavity or depression 210 in the mounting plate 102 can also be used with a reflector that includes a similarly-sized reciprocal projection over the reflector, facilitating the removable attachment assembly 100 in easily mating with such a reflector.

FIG. 3A shows a bottom elevational view of the example attachment assembly 100 of FIG. 1. As particularly shown in FIG. 3A, the leaf-spring assemblies 118, 138 are secured to the mounting plate 102 along a first end 300 of the mounting plate 102 via fasteners (e.g., rivets) 125, 145, enabling the leaf-spring assemblies 118, 138 to be biased away from a second end 302 of the mounting plate 102, as shown by reference 304.

FIG. 3B shows a bottom elevational view of the alternate removable attachment assembly of FIG. 2B. As particularly shown in FIG. 3B, a closed projecting structure 306 can be formed by the cavity 210 of FIG. 2B to increase the biasing of the leaf-spring assemblies 118, 138 with respect to the second end 302 of the mounting plate 102. Specifically, the projecting structure 306 includes peripheral walls 308, 310 that rise substantially upward from the mounting plate 102. The leaf-spring assemblies 118, 138 extend over peripheral wall 308 that directs the leaf-spring assemblies 118, 138 farther away from the second end 302 of the mounting plate 102, as shown by reference 312. In operation, the peripheral wall 310 can further bias the leaf-spring assemblies 118, 138 away from the second end 302 of the mounting plate 102, as will be described in greater detail hereinbelow.

In other example embodiments, the projecting structure 306 can be replaced by a raised bead, projection, wall, bridge or other structure formed on or in the mounting plate 102 at the first end 300 of the of the mounting plate 102 (disposed subsequent to fasteners 125, 145) to increase the biasing of the leaf-spring assemblies 118, 138 with respect to the second end 302 of the mounting plate 102.

Although the following description generally refers to the removable attachment assembly 100 of FIG. 1 for simplicity and clarity, it should nonetheless be understood that any alternate embodiments described thus far (e.g., FIGS. 2B, 3B) and generally herein can be used instead and, therefore, such alternate embodiments are contemplated by the following description.

FIG. 4 shows the example attachment assembly 100 of FIG. 1 in a first partially attached position with regard to a housing 400 of a droplight. The housing 400 includes a reflector 402 and a wire guard 408.

The reflector 402 of the housing 400 is configured to reflect light emitted by a light bulb that is to be disposed within the housing 400. The reflector 402 includes an attachment member 404 and a rim 406. The attachment member 404 is configured to removably secure or couple the housing 400 (via reflector 402) to a handle that supports an electrical socket (receiving a light bulb) connected to an extension cord.

As shown in FIG. 4, the attachment assembly 100 is disposed over the reflector 402. Specifically, the mounting plate 102 of the attachment assembly 100 mates with the reflector 402 in a generally flat configuration, while hooks 122, 142 secure the leaf-spring members 120, 140 of the respective leaf-spring assemblies 118, 138 to a first side 405 of the rim 406. A user can use the handles 124, 144 to assist (e.g., using user's thumb) in securing the hooks 122, 142 to the first side 405 of the rim 406. In some embodiments, the reflector 402 can have projection (not shown) over the reflector 402 that is similar to the projection 306 of FIG. 3B. In such embodiments, the removable attachment assembly 100 shown in FIGS. 2B, 3B can be used to securely mate the removable attachment assembly to the reflector 402, such that the projection 306 fits over the projection of the reflector 402.

The wire guard 408 of the housing 400 is removably hinged to the reflector 402 to facilitate transmission of light and replacement of the light bulb that is disposed within the housing 400. The wire guard 408 can also include hook 410 to permit hanging the housing 400 (connected to the handle that supports the electrical socket connected to the extension cord) on a hook-supporting structure in close proximity to a desired work area.

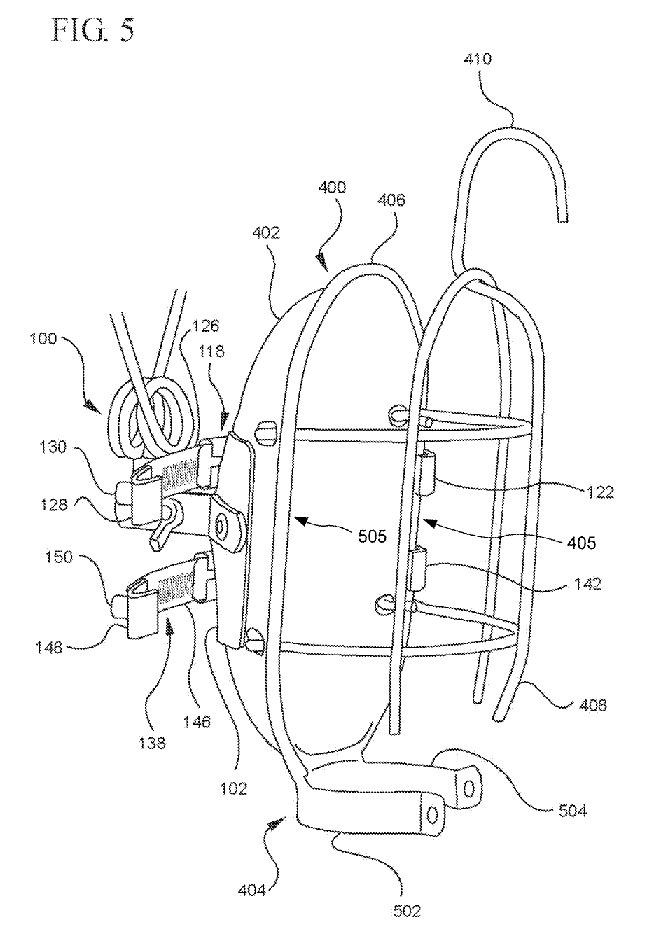

FIG. 5 shows the example attachment assembly 100 of FIG. 4 in a second biased position with regard to the housing 400 of a droplight. As shown in FIG. 5, the mounting plate 102 is mated with the reflector 402 in a flat configuration and the hooks 122, 142 secure leaf-spring members 120, 140 of the respective leaf-spring assemblies 118, 138 to the first side 405 of the rim 406. The leaf-spring assemblies 118, 138 are biased away with respect to the second side 505 of the rim 406.

As further shown in FIG. 5, the attachment member 404 includes arcuate arms 502, 504 configured to removably secure or couple the housing 400 (via reflector 402) to a handle that supports an electrical socket (receiving a light bulb) connected to an extension cord, as will be described in greater detail below.

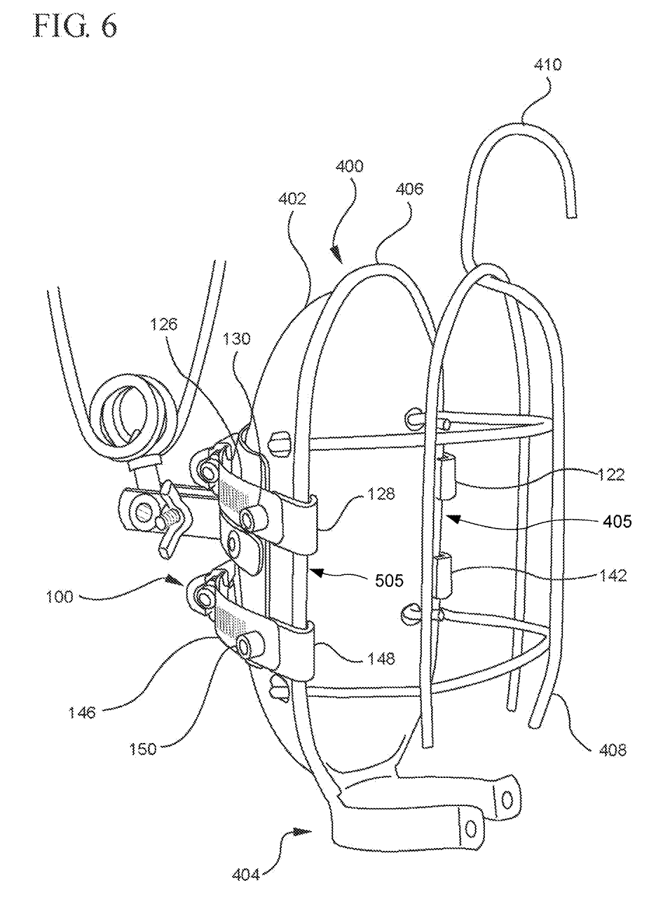

FIG. 6 shows the example attachment assembly 100 of FIG. 5 in a third fully attached position with regard to the housing 400 of a droplight. As shown in FIG. 6, the mounting plate 102 is mated with the reflector 402 in a flat configuration and the hooks 122, 142 secure the leaf-spring members 120, 140 of the respective leaf-spring assemblies 118, 138 to the first side 405 of the rim 406.

As is further shown in FIG. 6, the respective leaf-spring assemblies 118, 138 have been deflected down and peripherally out with respect to the housing 400 and the hooks 128, 148 have been secured to the second side 505 of the rim 406 of the reflector 402. The user can use the handles 130, 150 of the respective leaf-spring members 126, 146 to assist (e.g., using user's thumb) in deflecting the leaf-spring assemblies 118, 138 and in securing the hooks 128, 148 to the rim 406. The biasing of the leaf-spring assemblies 118, 138 away from the second side 505 of the reflector 402 enables the hooks 128, 148 to secure to the second side 505 of the rim 406 of the reflector 402 once the hooks 128, 148 have been deflected past the rim 406 and the handles 130, 150 have been released. More specifically, as the handles 130, 150 are released after the deflection of the leaf-spring assemblies 118, 138, the tension in the leaf-spring assemblies 118, 138 pulls the hooks 128, 148 in the reverse direction, opposite to the direction of the deflection, and engages the hooks 128, 148 to the second side 505 of the rim 406. The second peripheral wall 310 shown in FIG. 3B can provide additional biasing of the leaf-spring assemblies 118, 138 away from the second side 505 of the reflector 402, facilitating the hooks 128, 148 in securely hooking the rim 406 of the reflector 402.

The user can also disconnect or remove the attachment assembly 100 from the reflector 402 of the housing 400 by using the handles 130, 150 to assist (e.g., using user's thumb) in extending the leaf-spring assemblies 118, 138 peripherally out with respect to the second side 505 of the rim 406 until the hooks 128, 148 release or clear from the second side 505 of the rim 406.

FIG. 7 shows the example attachment assembly 100 of FIG. 1 securing a droplight 700 to a supporting structure 712. The supporting structure 712 can be a structure that has at least one substantially flat surface, such as a block. The droplight 700 includes a housing 400 of FIG. 4 and a handle 702. The arms 502, 504 of the attachment member 404 removably secure the housing 400 to the handle 702 via a fastener 710 (e.g., a screw). Other attachment members can be used instead of the attachment member 404.

The handle 702 of the droplight 700 includes a socket 704 and an extension cord 706. The socket 704 is configured to receive a light bulb 708 and the extension cord 706 is configured connect the socket 704 to an electrical outlet (not shown) to supply an electric current to the light bulb 708. The light bulb 708 can be incandescent, fluorescent, light-emitting-diode (LED), as well as any other type of light bulb capable of being received into the housing 400 and the socket 704 to provide light via the electric current provided by the extension cord 706.

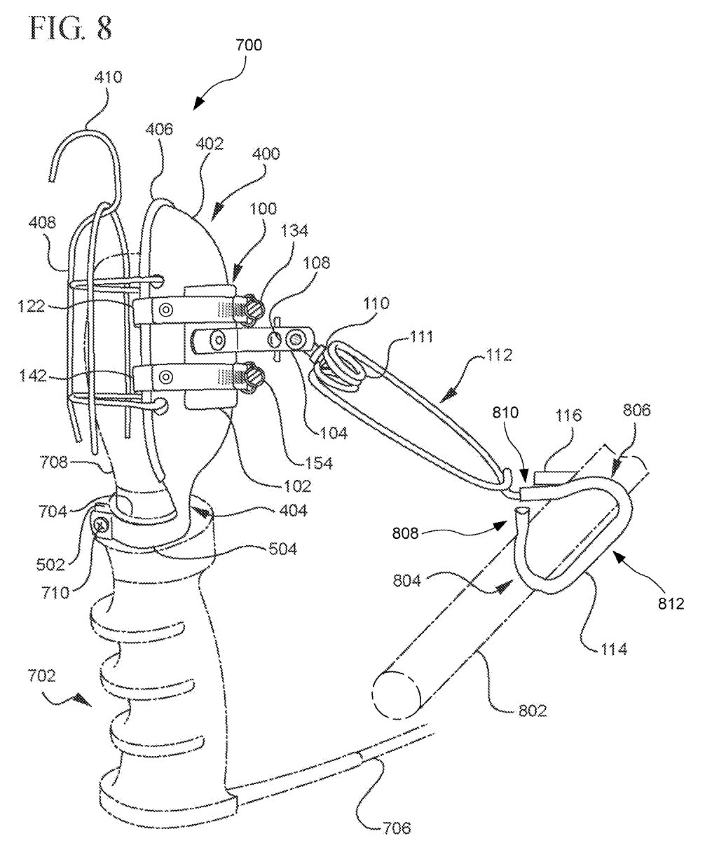

FIG. 8 shows the example attachment assembly of FIG. 1 that secures the droplight 700 to a supporting structure 712 or 802. The supporting structure 802 can be a structure that has a substantially arcuate surface (e.g., structure having circular or elliptical cross-section), such as a pipe. The clamp 112 of FIG. 8 is the same as in FIG. 7, except that each of the tongues 114, 116 includes reciprocal grooves 804, 806 to facilitate the clamp 112 in securing the droplight 700 about the supporting structure 802. In addition, each of the tongues 114, 116 also includes a plurality of reciprocal flat surfaces 808, 810, 812 to facilitate the clamp 112 in securing the droplight 700 to the supporting structure 712, as shown in FIG. 7.

In operation, the attachment assembly 100 of FIG. 1 is secured to the housing 400 of the droplight 700, as described hereinabove in connection with FIGS. 4-6. It is noted that the attachment assembly 100 of FIG. 1 can be connected to an assembled droplight 700, in which the housing 400 is connected to the handle 702, or to the housing 400 before connection to the handle 702. The clamp 112 of the attachment assembly 100 can be secured to the supporting structure 712 or 802 in a desired location of a work area using the tongues 114, 116.

After securing the attachment assembly 100 to the droplight 700, the position of the droplight 700 with respect to the supporting structure 712 or 802 can be adjusted in multiple degrees of freedom via the attachment assembly 100 described herein. Specifically, the clamp 112 can be pivotally and rotationally adjusted in relation to the droplight 700 via the connector 110 and the coils 111. In addition, the fastener 108 (e.g., bolt secured by wing nut) can be loosened and tightened to provide more or less grip (friction) of the connector 110 between the brackets 104, 106.

Thus, an example removable attachment assembly for a droplight and a method of attaching a droplight have been described herein. The attachment assembly provides the ability to secure the droplight in close proximity to the work area where additional light may be required, especially when the work area lacks a hook-supporting structure. In addition, the attachment assembly mitigates the complex and often cumbersome connection and disconnection of the prior art mounts or supports. As a result, the attachment assembly makes its use and reusability practical, contributing to its commercial desirability.

Although specific example embodiments have been described, it will be evident that various modifications and changes may be made to these embodiments without departing from the broader scope of the embodiments. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments shown are described in sufficient detail to enable those skilled in the art to practice the teachings disclosed herein. Other embodiments may be utilized and derived therefrom, such that structural substitutions and changes may be made without departing from the scope of embodiments. This Detailed Description, therefore, is not to be taken in a limiting sense, and the scope of various embodiments is defined only by the appended claims, along with the full range of equivalents to which such claims are entitled.

Although specific embodiments have been shown and described herein, it should be appreciated that any arrangement calculated to achieve the same purpose may be substituted for the specific embodiments shown. This application is intended to cover any and all adaptations or variations of various embodiments. Combinations of the above embodiments and other embodiments not specifically described herein will be apparent to those of skill in the art upon reviewing the above description.

The Abstract is provided to comply with 37 C.F.R. §1.72(b) and will allow the reader to quickly ascertain the nature of the technical disclosure of this application. It is submitted with the understanding that it will not be used to interpret or limit the scope or meaning of the claims.

In the foregoing description, various features may be grouped together in a single embodiment for the purpose of streamlining the disclosure of this application. This method of disclosure is not to be interpreted as reflecting that the claimed embodiments have more features than are expressly recited in each claim. Rather, as the following claims reflect, inventive subject matter lies in less than all features of a single disclosed embodiment.

What is claimed is:

1. An attachment assembly for a droplight, the droplight including a reflector having a rim, the attachment assembly comprising:
a mounting plate configured to be disposed over the reflector of the droplight;
at least one leaf-spring assembly secured to a first end of the mounting plate and biased away from a second end of the mounting plate, the at least one leaf-spring assembly including a first hook configured to engage a first side of the rim and a second hook configured to engage a second side of the rim; and
a clamp secured to the mounting plate in adjustable configuration and configured to secure the mounting plate to a supporting structure.

2. The attachment assembly for a droplight of claim 1, wherein the mounting plate is of an accurate configuration.

3. The attachment assembly for a droplight of claim 1, wherein the mounting plate includes a structure at approximately a center of its arcuate configuration, the structure including at least one wall that extends substantially upward, the at least one wall configured to increase the biasing of the at least one leaf-spring assembly with respect to the second end of the mounting plate.

4. The attachment assembly for a droplight of claim 1, wherein a raised bead, projection, wall, bridge or other structure is formed on or in the mounting plate at the first end of the mounting plate to increase the biasing of the leaf-spring assembly with respect to the second end of the mounting plate.

5. The attachment assembly for a droplight of claim 1, wherein the at least one leaf-spring assembly includes:
a first leaf-spring member;
a second leaf-spring member; and
leaf-spring adjustment member configured to adjust the second leaf-spring member with respect to the first leaf-spring member.

6. The attachment assembly for a droplight of claim 5, wherein the first hook is secured to the first leaf-spring member and the second hook is secured to the second leaf-spring member.

7. The attachment assembly for a droplight of claim 5, wherein the first hook is configured from the first leaf-spring member and the second hook is configured from second leaf-spring member.

8. The attachment assembly for a droplight of claim 5, wherein the leaf-spring adjustment member is a worm drive.

9. The attachment assembly for a droplight of claim 8, wherein the second leaf-spring member includes a plurality of slots configured to be driven by the worm drive.

10. The attachment assembly for a droplight of claim 1, wherein each of the at least one leaf-spring assembly includes one leaf-spring member having the first hook at a first end of the leaf-spring member and the second hook at a second end of the leaf-spring member.

11. The attachment assembly for a droplight of claim 10, wherein the first hook is secured to the first end of the leaf-spring member and the second hook is secured to the second end of the leaf-spring member.

12. The attachment assembly for a droplight of claim 10, wherein the first hook is configured from the first end of the leaf-spring member and the second hook is configured from the second end of the leaf-spring member.

13. The attachment assembly for a droplight of claim 1, wherein the at least one leaf-spring assembly includes at least one handle, ridge, knurl, bead or protrusion configured to assist in engagement of the first hook or the second hook.

14. The attachment assembly for a droplight of claim 13, wherein the at least one handle secures the first hook or the second hook to the at least one leaf-spring assembly.

15. The attachment assembly for a droplight of claim 1, wherein the attachment assembly further comprises:
a first bracket disposed at the first end of the mounting plate;
a second bracket disposed at the second end of the mounting plate;
a connector configured to be adjustably secured between the first bracket and the second bracket, the connector further configured to secure the clamp in adjustable configuration with respect to the mounting plate.

16. The attachment assembly for a droplight of claim 15, wherein the first bracket and the second bracket are secured to the mounting plate or are monolithic with the mounting plate.

17. The attachment assembly for a droplight of claim 15, wherein the clamp includes:
a first tongue;
a second tongue; and
a plurality of coils configured to bias the first tongue closed with respect to the second tongue.

18. The attachment assembly for a droplight of claim 17, wherein the first tongue and the second tongue include reciprocal grooves configured to secure about a supporting structure having a substantially arcuate surface.

19. The attachment assembly for a droplight of claim 17, wherein the first tongue and the second tongue include reciprocal surfaces configured to secure about a supporting structure having at least one substantially flat surface.

20. The attachment assembly for a droplight of claim 17, wherein the plurality of coils are biased toward one another to secure the connector between the plurality of coils.

21. A method of attaching a droplight, the droplight including a reflector having a rim, the method comprising:
disposing a mounting plate of an attachment assembly over the reflector of the droplight, the attachment assembly including at least one leaf-spring assembly secured to a first end of the mounting plate and biased away from a second end of the mounting plate and an adjustable clamp;
securing the at least one leaf-spring assembly to a first side of the rim;
deflecting the at least one leaf-spring assembly downward and peripherally outward with respect to a second side of the rim; and
securing the at least one leaf-spring assembly to the second side of the rim.

22. The method of attaching a droplight of claim 21, further comprising:
securing the mounting plate in adjustable configuration to a supporting structure.

23. The method of attaching a droplight of claim 22, further comprising:
adjusting the reflector with respect to the supporting structure.

24. The method of attaching a droplight of claim 21, wherein securing the at least one leaf-spring assembly to the first side of the rim includes securing a first hook of the at least one leaf-spring assembly to the first side of the rim.

25. The method of attaching a droplight of claim 21, wherein securing the at least one leaf-spring assembly to the second side of the rim includes securing a second hook of the at least one leaf-spring assembly to the second side of the rim.

26. The method of attaching a droplight of claim 21, further comprising adjusting a length of the at least one leaf-spring assembly with respect to the reflector.

27. The method of attaching a droplight of claim 21, wherein adjusting the length of the leaf-spring assembly includes:
adjusting a first leaf-spring member of the at least one leaf-spring assembly with respect to a second leaf-spring member of the at least one leaf-spring assembly.

28. The method of attaching a droplight of claim 21, further comprising:
deflecting the at least one leaf-spring assembly peripherally outward with respect to the second side of the rim to release the at least one leaf-spring from the second side of the rim; and
removing the attachment assembly from the reflector of the droplight.
